(19) United States
(12) Patent Application Publication
(10) Pub. No.: US 2007/0297612 A1
(43) Pub. Date: Dec. 27, 2007

(54) METHOD, DEVICE AND SYSTEM OF ENCRYPTED WIRELESS COMMUNICATION

(76) Inventors: MEIR FEDER, Herzliya (IL); Shay Freundlich, Givat Ada (IL); Noam Geri, Los Altos, CA (US)

Correspondence Address: EITAN MEHULAL LAW GROUP, 116 JOHN ST,, SUITE 1201, NEW YORK, NY, 10038, US

(21) Appl. No.: 11/768,518

(22) Filed: Jun. 26, 2007

Related U.S. Application Data
(63) Continuation-in-part of application No. 11/551,641, filed on Oct. 20, 2006.
(60) Provisional application No. 60/806,410, filed on Jun. 30, 2006.
(60) Provisional application No. 60/729,459, filed on Oct. 21, 2005.

(51) Int. Cl. H04K 1/00

(52) U.S. Cl. 380/270

(57) ABSTRACT

Some demonstrative embodiments of the invention include devices, systems and/or methods of encrypted wireless communication. Some demonstrative embodiments of the invention include a wireless transmitter to generate an encrypted wireless transmission corresponding to an input signal. The transmission may include at least first and second encrypted streams of symbols encrypted according to at least first and second different encryption schemes, respectively. Other embodiments are described and claimed.

### CROSS-REFERENCE

This application claims the benefit of U.S. Provisional Patent application 60/806,410, entitled “Method for encrypting wireless transmitted data”, filed Jun. 30, 2006; and is a Continuation in Part of U.S. patent application Ser. No. 11/551,641, entitled “Apparatus and method for uncompressed, wireless transmission of video”, filed Oct. 20, 2006, which claims the benefit of U.S. Provisional Patent application 60/729,459, entitled “Apparatus and method of uncompressed, wireless transmission of video”, filed Oct. 21, 2005, the entire disclosures of all of which are incorporated herein by reference.

### FIELD

Some embodiments relate generally to the field of wireless communication and, more particularly, to encrypted wireless communication.

### BACKGROUND

Wireless communication has rapidly evolved over the past decades. Even today, when high performance and high bandwidth wireless communication equipment is made available there is demand for even higher performance at a higher bandwidth. As many wireless communication systems are susceptible to intrusion, it may be desirable to protect the wireless transmission.

### SUMMARY

Some demonstrative embodiments of the invention include devices, systems and/or methods of encrypted wireless communication.

Some demonstrative embodiments of the invention include a wireless transmitter to generate an encrypted wireless transmission corresponding to an input signal. The transmission may include at least first and second encrypted streams of symbols encrypted according to at least first and second different encryption schemes, respectively.

According to some demonstrative embodiments of the invention, the first and second encrypted streams may include symbols of first and second different constellations, respectively.

According to some demonstrative embodiments of the invention, the first and second constellations may include a fine constellation, and a coarse constellation, respectively.

According to some demonstrative embodiments of the invention, the first and second encrypted streams may represent a plurality of transformation coefficients corresponding to the input signal.

According to some demonstrative embodiments of the invention, the transmitter may include an encryptor to generate the first and second encrypted streams by encrypting first and second symbol streams representing the input signal.

According to some demonstrative embodiments of the invention, the encryptor may include an encryption code generator to generate one or more encryption codes; a first encryption module to encrypt the first symbol stream using the encryption codes according to the first encryption scheme; and a second encryption module to encrypt the second symbol stream using the encryption codes according to the second encryption scheme.

According to some demonstrative embodiments of the invention, the encryption code generator generates the encryption codes corresponding to a plurality of transmission frames.

According to some demonstrative embodiments of the invention, the transmission may include encryption information corresponding to the encryption codes.

According to some demonstrative embodiments of the invention, the encryption information may include one or more encryption keys.

According to some demonstrative embodiments of the invention, the transmitter may include a coefficient generator to apply a transformation to the input signal to generate a plurality of transformation coefficients representing the input signal; and a mapper to map the transformation coefficients to the first and second symbol streams.

According to some demonstrative embodiments of the invention, the input signal may include a video signal, e.g., a high-definition-television signal.

Some demonstrative embodiments of the invention include a wireless receiver to receive an encrypted wireless transmission representing an input signal and to decrypt the transmission into an output signal corresponding to the input signal. The transmission may include at least first and second encrypted streams of symbols encrypted according to at least first and second different encryption schemes respectively.

According to some demonstrative embodiments of the invention, the first and second encrypted streams may include symbols of first and second different constellations, respectively.

According to some demonstrative embodiments of the invention, the first and second constellations may include a fine constellation, and a coarse constellation, respectively.

According to some demonstrative embodiments of the invention, the first and second encrypted streams may represent a plurality of transformation coefficients, and the output signal may be based on the plurality of transformation coefficients.

According to some demonstrative embodiments of the invention, the receiver may include a decryptor to decrypt the first and second encrypted streams into first and second decrypted symbol streams.

According to some demonstrative embodiments of the invention, the decryptor may include an encryption code generator to generate one or more decryption codes; a first decryption module to decrypt the first encrypted stream using the decryption codes according to a first decryption scheme corresponding to the first encryption scheme; and a second decryption module to decrypt the second encrypted stream using the decryption codes according to a second decryption scheme corresponding to the second encryption scheme.

According to some demonstrative embodiments of the invention, the decryption code generator may generate the decryption codes corresponding to a plurality of received transmission frames.

According to some demonstrative embodiments of the invention, the received transmission may include encryption information. The decryption code generator may generate the decryption codes based on the encryption information.

According to some demonstrative embodiments of the invention, the encryption information may include one or more encryption keys used to encrypt the first and second encrypted streams.

According to some demonstrative embodiments of the invention, the output signal may include a video signal, e.g., a high-definition-television signal.

Some demonstrative embodiments include a wireless communication system including a source module to generate a signal to be transmitted to a destination module; and a wireless transmitter to generate an encrypted wireless transmission corresponding to the signal. The transmission may include at least first and second encrypted streams of symbols encrypted according to at least first and second different encryption schemes, respectively.

According to some demonstrative embodiments of the invention, the source module may include a video source, and the signal may include a video signal.

According to some demonstrative embodiments of the invention, the system may include a receiver to receive the encrypted wireless transmission and to decrypt the transmission into an output signal.

Some demonstrative embodiments of the invention include a method of encrypted wireless communication, the method including transmitting an encrypted wireless transmission corresponding to an input signal. The transmission may include at least first and second encrypted streams of symbols encrypted according to at least first and second different encryption schemes, respectively.

Some demonstrative embodiments of the invention include a method of encrypted wireless communication, the method including receiving an encrypted wireless transmission representing an input signal; and decrypting the transmission into a decrypted output signal corresponding to the input signal. The transmission may include at least first and second encrypted streams of symbols encrypted according to at least first and second different encryption schemes, respectively.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of a wireless communication system, in accordance with some demonstrative embodiments of the invention;

FIG. 2 is a schematic illustration of a wireless transmitter, in accordance with some demonstrative embodiments of the invention;

FIG. 3 is a schematic illustration of a symbol mapping scheme, in accordance with some demonstrative embodiments of the invention;

FIG. 4 is a schematic illustration of a wireless receiver, in accordance with some demonstrative embodiments of the invention;

FIG. 5 is a schematic flow-chart illustration of a method of synchronizing encryption information, in accordance with some demonstrative embodiments of the invention; and

FIG. 6 is a schematic flow-chart illustration of a method of generating an encrypted wireless transmission, in accordance with some demonstrative embodiments of the invention.

### DETAILED DESCRIPTION

In the following detailed description numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments of the invention may be used in a variety of applications. Although embodiments of the invention are not limited in this respect, one or more of the methods, devices and/or systems disclosed herein may be used to wirelessly transmit encrypted video signals, for example, High-Definition-Television (HDTV) signals, between a video source and a video destination. In other embodiments, the methods, devices and/or systems disclosed herein may be used to transmit any other suitable signals, e.g., between any suitable source and/or destination.

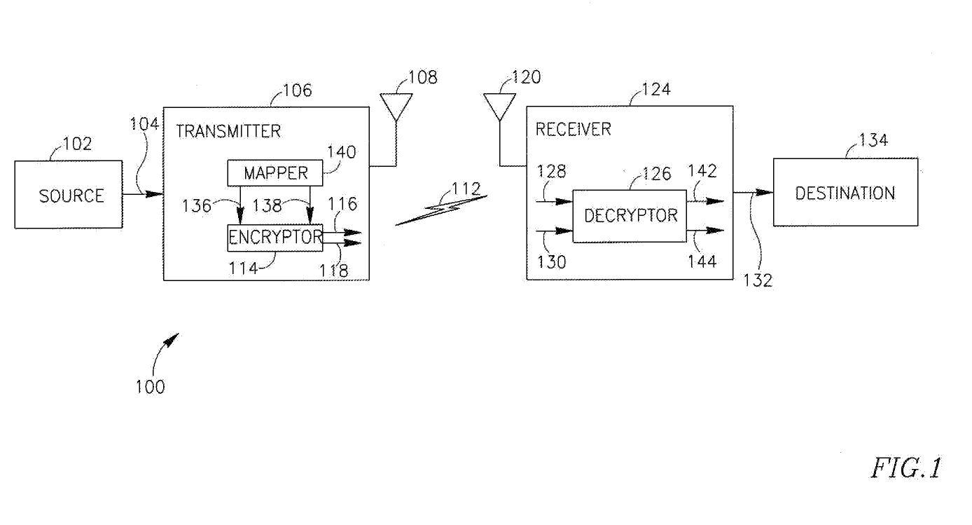

Reference is made to FIG. 1, which schematically illustrates a wireless communication system 100, in accordance with some demonstrative embodiments of the invention.

According to some demonstrative embodiments of the invention, system 100 may include a wireless transmitter 106 to transmit an encrypted wireless transmission 112 based on input signals 104 received from a source module 102. For example, transmitter 106 may a generate an encrypted wireless transmission including at least first and second encrypted streams of symbols encrypted according to at least first and second different encryption schemes, respectively, as described below. Source module 102 may include any suitable software and/or hardware to generate signals 104, e.g., as described below.

According to some demonstrative embodiments of the invention, encrypted transmission 112 may include symbols of a plurality of streams encrypted according to a plurality of encryption schemes, as described in detail below.

According to some demonstrative embodiments of the invention, encrypted transmission 112 may include symbols of first and second streams encrypted according to first and second encryption schemes, e.g., as described in detail below. In one example, the first and second streams may include symbols of first and second different constellations, respectively. For example, the first and second streams may include symbols of a coarse constellation and a fine constellation, respectively, e.g., as described below.

According to some demonstrative embodiments of the invention, transmitter 106 may include an encryptor 114 to generate a plurality of encrypted streams, e.g., encrypted streams 116 and 118, by encrypting a plurality of respective streams, e.g., streams 136 and 138, in accordance with a plurality of encryption schemes.

According to some demonstrative embodiments of the invention, encrypted streams 116 and 118 may include symbols of two respective constellation types. For example, encrypted stream 116 may include symbols of a first constellation, e.g., a fine constellation; and encrypted stream 118 may include symbols of a second constellation, e.g., a coarse constellation, as described in detail below.

According to some demonstrative embodiments of the invention, streams 136 and 138 may represent at least part of input signals 104. For example, transmitter 106 may include a mapper 140 to map one or more values, e.g., transformation coefficients, corresponding to signals 104 to streams 136 and 138, e.g., according to the first and second constellations. In one example, stream 136 may include symbols of the first constellation, and stream 138 may include symbols of the second constellation, e.g., as described below.

According to some demonstrative embodiments of the invention, transmitter 106 may include at least one antenna to transmit encrypted transmission 112 including the symbols of the plurality of encrypted streams. Transmitter 106 may implement any suitable transmission method and/or configuration to transmit transmission 112. Although embodiments of the invention are not limited in this respect, in some demonstrative embodiments of the invention, transmitter 106 may generate transmission 112 according to an Orthogonal-Division-Frequency-Multiplexing (OFDM) transmission scheme. According to other embodiments, transmitter 106 may generate transmission 112 according to any other suitable transmission scheme.

According to some demonstrative embodiments of the invention, system 100 may also include a wireless receiver 124 having at least one antenna 120 to receive encrypted transmission 112. Receiver 124 may decrypt encrypted transmission 112, and generate output signals 132, e.g., corresponding to signal 104. Signals 132 may be provided to a destination module 134, which may include any suitable software and/or hardware to handle signals 132 in any suitable manner, e.g., as described below.

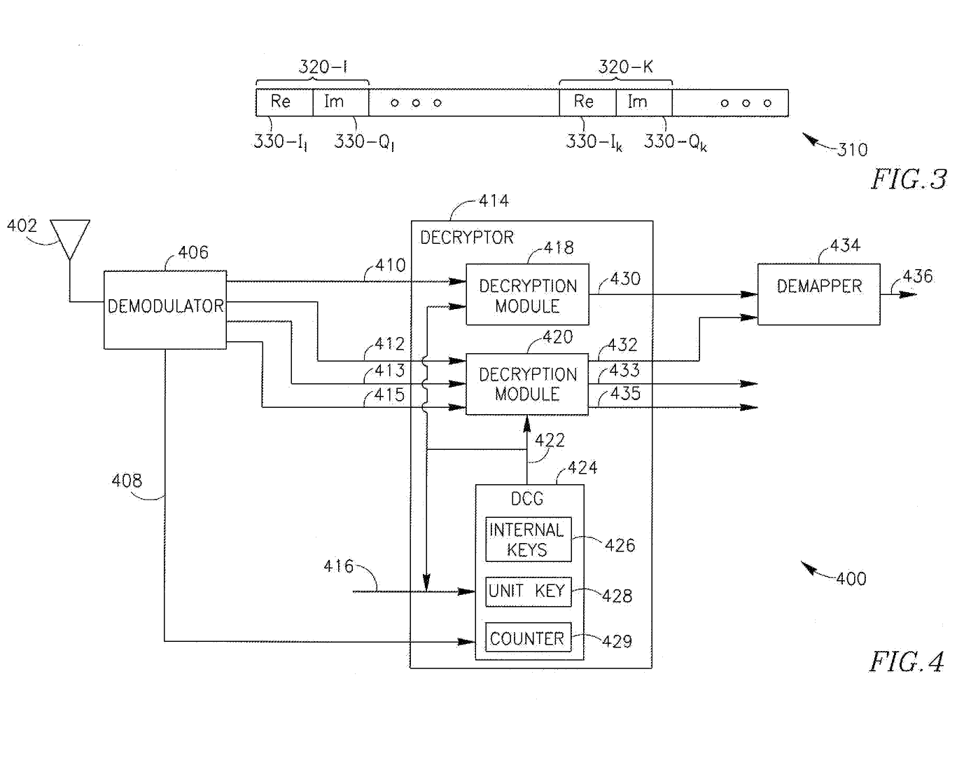

According to some demonstrative embodiments of the invention, receiver 124 may include a decryptor 126 to decrypt a plurality of received encrypted streams corresponding to transmission 112 into a plurality of respective decrypted streams. For example, decryptor 126 may decrypt encrypted streams 128 and 130, corresponding to transmission 112, into decrypted streams 142 and 144, respectively, e.g., as described in detail below with reference to FIG. 4. In one example, stream 128 may include symbols of the first constellation, and stream 130 may include symbols of the second constellation, e.g., as described below.

Although embodiments of the invention are not limited in this respect, in some demonstrative embodiments signals 104 may include video signals in any suitable video format. In one example, signals 104 may include HDTV video signals, for example, uncompressed HDTV signals, e.g., in a Digital Video Interface (DVI) format, a High Definition Multimedia Interface (HDMI) format, or any other suitable video format. According to these embodiments, source module 102 may include any suitable video source, for example, a set-top box, a computer, a game console, a Video Cassette Recorder (VCR), a Digital Video Disc (DVD), and the like. Destination module 134 may include, for example, a display or screen, e.g., a flat screen display, a Liquid Crystal Display (LCD), a plasma display, a television, and the like. Accordingly, transmission 112 may include, for example, a HDTV video transmission, which may include, for example, a modem-frame, e.g., contained in 2400 OFDM frames, each OFDM frame containing, for example, 128 symbols. In other embodiments, signals 104 may include any other suitable signals, and/or source 102 and/or destination 134 may include any other modules. In one example, signals 104 may include audio, voice, control and/or data signals, e.g., as described below.

Although embodiments of the invention are not limited in this respect, types of antennae that may be used for antennas 108 and/or 120 may include but are not limited to internal antenna, dipole antenna, omni-directional antenna, a monopole antenna, an end fed antenna, a circularly polarized antenna, a micro-strip antenna, a diversity antenna and the like.

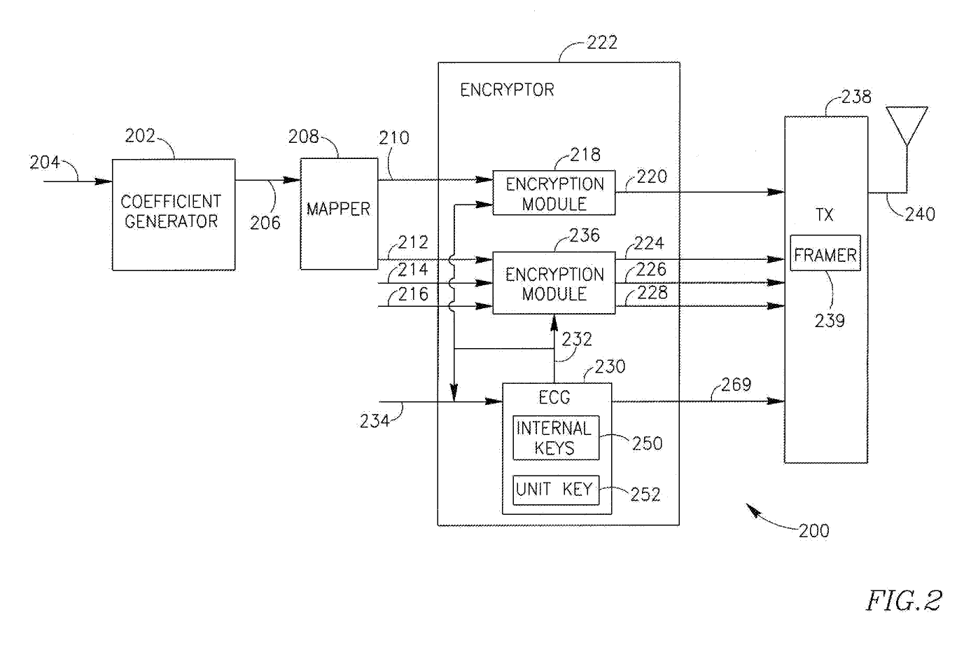

Reference is now made to FIG. 2, which schematically illustrates a wireless transmitter 200, in accordance with some demonstrative embodiments of the invention. Although embodiments of the invention are not limited in this respect, according to some demonstrative embodiments of the invention, transmitter 200 may perform the functionality of transmitter 106 (FIG. 1).

According to some demonstrative embodiments of the invention, transmitter 200 may include an encryptor 222 to generate a plurality of encrypted streams, e.g., including streams 220, 224, 226 and/or 228, by encrypting a plurality of respective streams, e.g., including streams 210, 212, 214 and/or 216, in accordance with a plurality of encryption schemes, e.g., as described in detail below.

Although embodiments of the invention are not limited in this respect, according to some demonstrative embodiments of the invention encryptor 222 may perform the functionality of encryptor 114 (FIG. 1).

According to some demonstrative embodiments of the invention, encryptor 222 may include a plurality of encryption modules to implement the plurality of encryption schemes, respectively. Encryptor 222 may include, for example, a first encryption module 218 to implement a first encryption scheme, and a second encryption module 236 to implement a second encryption scheme. For example, encryption module 218 may encrypt stream 210 into encrypted stream 220 using the first encryption scheme; and encryption module 236 may encrypt streams 212, 214, and/or 216 into encrypted streams 224, 226, and/or 228, respectively, using the second encryption scheme.

Although embodiments of the invention are not limited in this respect, according to some demonstrative embodiments of the invention streams 210 and 212 may include symbols of first and second transmission constellations, respectively, e.g., as described in detail below. According to these embodiments, encrypted stream 220 may include encrypted symbols of the first constellation encrypted according to the first encryption scheme, and encrypted stream 224 may include encrypted streams of the second constellation encrypted according to the second encryption scheme.

Although embodiments of the invention are not limited in this respect, according to some demonstrative embodiments of the invention streams 210 and 212 may include symbols representing an input video signal 204. For example, stream 210 may include fine constellation symbols corresponding to signal 204, and stream 212 may include coarse constellation symbols corresponding to signal 204, as described below.

According to some demonstrative embodiments of the invention, transmitter 200 may also include a coefficient generator 202 to generate a plurality of transformation coefficients 206 corresponding to video signal 204. In one example, coefficient generator 202 may generate coefficients 206 by applying a de-correlating transformation, e.g., a Discrete-Cosine-Transformation (DCT), to signals 204, e.g., as described in U.S. patent application Ser. No. 11/551,641, entitled “Apparatus and method for uncompressed, wireless transmission of video”, filed Oct. 20, 2006, and published May 3, 2007, as U.S. Patent Application Publication US 2007-0098063 (“the '641 Application”), the entire disclosure of which is incorporated herein by reference. For example, coefficient generator 202 may include a transform unit (not shown) to perform the de-correlating transformation on component data, e.g., in the format Y—Cr—Cb, representing pixels of signals 204, e.g., as described in the '641 Application. Coefficient generator 202 may optionally include a color converter (not shown) to convert color components of signal 204 into the component data, e.g., as described in the '641 Application.

According to some demonstrative embodiments of the invention, transmitter 200 may also include a mapper 208 to map transformation coefficients 206 to streams 210 and 212, e.g., as described in the '641 Application. In one example, mapper 208 may map Most Significant Bits (MSBs) and Least Significant Bits (LSBs) of coefficients 206 to streams 210 and 212 based on any suitable mapping criterion.

According to some demonstrative embodiments of the invention, stream 210 may include values of fine constellation symbols, and stream 212 may include values of coarse constellation symbols, e.g., as described in the '641 Application. For example, mapper 208 may map the MSBs representing quantized values of a first set of one or more of coefficients 206, e.g., including one or more low frequency coefficients, to stream 212, Mapper 208 may map to stream the LSBs representing quantization errors of the first set of coefficients, and/or values of a second set of one or more of coefficients 206, e.g., including high frequency coefficients, as described in the '641 Application. In one example, coefficients 206 are represented by 11-bit values. According to this example, mapper 208 may map three MSBs of each of a plurality of low frequency coefficients to a respective coarse-constellation symbol of stream 212; and map eight LSBs of each of the plurality of low frequency coefficients, together with values of a plurality of high-frequency coefficients to fine constellation symbols of stream 210. A fine constellation symbol of stream 210 may have real and imaginary components, each representing, for example, a LSB component of a coefficient of coefficients 206. A plurality of coarse constellation symbols of stream 212 may represent, for example, MSB components of a plurality of coefficients 206, respectively.

According to some demonstrative embodiments of the invention, streams 214 and 216 may include any suitable signals, information and/or data. In one example, stream 214 may include audio signals, which may be received, for example, from an audio coder (not shown). In another example, stream 216 may include control signals, which may be received, for example, from a modem controller (not shown). According to these examples, encryption module 236 may encrypt the audio signals of stream 214 and/or the control signals of stream 216 to generate stream 226 including encrypted audio signals, and stream 228 including encrypted control signals in accordance with the second encrypting scheme.

According to some demonstrative embodiments of the invention, transmitter 238 may also include a transmission (Tx) module 238 to transmit an encrypted wireless transmission including streams 230, 224, 226, an/or 228 over a wireless link via at least one antenna 240. Transmission module 238 may include any suitable wireless transmission module, for example, a transmission module able to transmit symbols of two different constellations, e.g., the fine constellation symbols of stream 220 and the coarse constellation symbols of stream 224. For example, Tx module 238 may include a framer 239 to generate OFDM frames including the fine constellation symbols of stream 220, the coarse constellation symbols of stream 224, the audio signals of stream 226, the control signals of stream 228 and/or any other signals, for example, pilot, timing, frequency tracking, and/or channel tracking signals, e.g., as described in the '641 Application.

According to some demonstrative embodiments of the invention, encryption modules 218 and 236 may use one or more encryption codes 232 to encrypt streams 210, 212, 214 and/or 216. For example, encryptor 222 may include at least one Encryption Code Generator (ECG) 230 to generate encryption codes 232, e.g., as described in detail below.

According to some demonstrative embodiments of the invention, encryption codes 232 may include any suitable random or pseudo-random values, e.g., represented by a sequence of bits. In one example, ECG 230 may generate encryption codes 232 in accordance with any suitable block cipher technique, method or scheme, e.g., as defined by the Data Encryption Standard (DES), the Advanced Encryption Standard (AES), and the like.

According to some demonstrative embodiments of the invention, ECG 230 may generate encryption codes 232 in synchronization with encryption codes implemented by a receiver intended to receive the transmissions transmitted by transmitter 200 (“the intended receiver”), e.g., as described in detail below with reference to FIGS. 4 and/or 5.

According to some demonstrative embodiments of the invention, ECG 230 may generate encryption codes 232 based on a plurality, of internal keys 250, a unit key 252, and an initial value 234. Keys 250 and 252, and initial value 234 may include any suitable values, e.g., represented by a sequence of bits. In one example, ECG 230 may maintain internal keys 250 in the form of a table.

According to some demonstrative embodiments of the invention, a value of unit key 252 may match a value of a unit key implemented by the intended receiver, e.g., as described in detail below with reference to FIGS. 4 and/or 5. For example, transmitter 200 may coordinate the value of unit key 252 with the intended receiver using any suitable key exchange mechanisms, e.g., in accordance with the Rivest-Shamir-Adleman (RSA) public key cipher, the Diffie-Hellman key exchange protocol, and the like.

According to some demonstrative embodiments of the invention, EGC 230 may generate encryption code 232 by encrypting initial value 234 using an encryption key resulting from a combination of unit key 252 and a selected internal key of internal keys 252. Encryption code 232 may be fed back as an input to ECG 230, such that additional codes 232 may be generated using a previous encryption code, e.g., instead of initial value 234. ECG 230 may select the selected internal key based on any suitable key selection criterion. For example, ECG 230 may re-select the internal key after a predefined number of frames, as described below.

Although some demonstrative embodiments of the invention are described above with reference to an encryptor, e.g., encryptor 222, including an ECG to generate encryption codes, e.g., encryption codes 232, to be provided to plurality encryption modules, e.g., encryption modules 218 and 236, in other embodiments of the invention the encryptor may include any other suitable configuration. For example, the encryptor may include a plurality of ECGs to generate the encryption codes of the plurality of encryption modules. In one example, at least first and second ECGs may generate at least first and second respective pluralities of encryption codes to be provided to the encryption modules.

According to some demonstrative embodiments of the invention, encryption module 218 may implement a first encryption scheme, e.g., to encrypt the fine constellation symbols of stream 210, and encryption module 236 may implement a second encryption scheme different than the first encryption scheme, e.g., to encrypt the coarse constellation symbols of stream 212, as described in detail below.

According to some demonstrative embodiments of the invention, the encryption scheme implemented by encryption module 236 to encrypt streams 212, 214 and/or 216 may include, for example, performing a logical operation on streams 212, 214, and/or 216 using encryption code 232. In one example, encryption module 236 may perform a logical Boolean operator, e.g., an Exclusive-OR (XOR) operation, between encryption code 232 and each of streams 212, 214 and/or 216.

According to some demonstrative embodiments of the invention, the encryption scheme implemented by encryption module 218 to encrypt stream 210 may include, for example, performing a scrambling operation to scramble an order of the symbols of stream 210. As described above, fine constellation symbols of stream 210 may include symbols of an OFDM scheme having real and imaginary components. As shown in FIG. 3, a symbol mapping scheme of an OFDM frame 310 may include a plurality of constellation symbols having real and imaginary components of a plurality of complex values. For example, symbol mapping scheme 310 may include symbols 320, e.g., including a symbol 320-k having imaginary and real components 330-Iₖ and 330-Qₖ, respectively, of a first complex value; and a symbol 320-1 having imaginary and real components 330-Iₗ and 230-Q₂, respectively, of a second complex value. Some of the symbols of scheme 310 may include the fine constellation symbols of stream 210, e.g. represented by the real and imaginary components of symbols 320. Encryption module 218 may scramble the fine constellation symbols, for example, by applying a random or pseudo-random permutation to the symbols. For example, encoding module, 218 may write chunks of a predefined number of symbols 320 into a memory or buffer in a first permutation, and reading the chunks according to a second permutation, e.g., different than the first permutation. The first and second permutations may be determined, for example, according to encryption codes 232. In some demonstrative embodiments, encryption module 218 may perform the permutations of the fine-constellation symbols between consecutive frames, e.g., a symbol can be sent in a frame succeeding or preceding a frame originally including the symbol (“the origin frame”).

According to some demonstrative embodiments of the invention, the encryption scheme implemented by encryption module 218 to encrypt stream 210 may include, for example, inverting one or more of the fine-constellation symbols. For example, the real or/and the imaginary components of symbols 320, may be multiplied either by −1 or +1 based, for example, on encryption codes 232.

According to some demonstrative embodiments of the invention, the encryption scheme implemented by encryption module 218 to encrypt stream 210 may include, for example, changing the phase of the complex value corresponding to the fine-constellation symbols based on encryption code 232. For example, the complex value of symbols 320 may be multiplied by e^{jα}, wherein the value of the phase α may be determined based on encryption code 232.

According to some demonstrative embodiments of the invention, the encryption scheme implemented by encryption module 218 to encrypt stream 210 may include, for example, multiplying the fine constellation symbols of streams 210 with a unitary matrix, wherein values of cells of the matrix mat be based on encryption code 232. For example, encryption module 218 may apply a Hadamard matrix including values based on encryption code 232. For example encryption module 218 may determine based on encryption code 232 which cells of the Hadamard matrix should have the value “1”, and which cells should have the value “1”.

According to some demonstrative embodiments of the invention, transmitter 200 may transmit, as part of the wireless transmission, encryption information corresponding to encryption code 232. For example, ECG 230 may provide transmission module 238 with encryption information 269 related to encryption code 232. Encryption information 269 may include one or more values to enable the intended receiver to synchronize a decryption code used to decrypt the wireless transmission with encryption code 232, e.g., as described below. In one example, encryption information 269 may include an Initial Value Offset (IVO), a key index, and a key index offset, e.g., as are described below.

According to some demonstrative embodiments of the invention, ECG 230 may use a different initial value 234, e.g., for encrypting different video frames. The initial value may be incremented with respect to a previous initial value, for example, according to a value of the IVO. ECG 230 may select the selected internal key of internal keys 250, based for example, on the value of the key index. The selection of the internal key may be performed after a number of frames defined by the key index offset. Transmission module 238 may include encryption information 269 as part of one or more frames of the wireless transmission. For example, framer 239 may include information 269 as part of a frame header of one or more of the frames, e.g., of substantially each of the frames.

According to some demonstrate embodiments of the invention, the encryption scheme implemented by encryption module 218 to encrypt stream 210 may include any other suitable encryption scheme. For example the encryption scheme may include a combination of two or more of the encryption schemes described above.

Some demonstrative embodiments of the invention are described above with reference to an encryptor, e.g., encryptor 222, including first and second encryption modules, e.g., encryption modules 218 and 236, to encrypt first and second streams, e.g., streams 210 and 212, of first and second respective types of signals, e.g., signals the fine constellation symbols and the coarse constellation symbols. However, in other embodiments of the invention the encryptor may include any other suitable configuration of a plurality of encryption modules to encrypt a plurality of streams. For example, the encryptor may include a first encryption module to perform a one-bit word encryption of the fine-constellation symbols, and a second encryption module to perform a two-bit word encryption of the coarse-constellation symbols.

Reference is now made to FIG. 4, which schematically illustrates a wireless receiver 400, in accordance with some demonstrative embodiments of the invention. Although embodiments of the invention are not limited in this respect, according to some demonstrative embodiments receiver 400 may perform he functionality of receiver 124 (FIG. 1).

According to some demonstrative embodiments of the invention, receiver 400 may include a demodulator 406 to demodulate wireless signals received via a plurality of antennas e.g., including at least one receive antenna 402. The received signals may include, for example, signals representing OFDM symbols, e.g., of an encrypted OFDM transmission, e.g., the encrypted transmission generated by transmitter 200 (FIG. 2). For example, the received signals may include symbols encrypted according to the plurality of encryption schemes described above with reference to FIG. 2.

According to some demonstrative embodiments of the invention, demodulator 406 may demodulate the received signals into a plurality of streams, e.g., as described in the '641 Application. For example, demodulator 406 may demodulate the received signals into a first stream 410 including symbols of a first type, e.g., fine-constellation symbols; and a second stream 420 including symbols of a second type, e.g., coarse-constellation symbols. Demodulator 406 may optionally demodulate the received signals into one or more additional streams, for example, streams 413 and/or 415, including any suitable signals, information and/or data. In one example, stream 413 may include encrypted audio signals corresponding, for example, to the audio signals of stream 226 (FIG. 2); and/or stream 415 may include encrypted control signals, corresponding for example, to the control signals of stream 228 (FIG. 2).

According to some demonstrative embodiments of the invention, demodulator 406 may also extract from the received signals encryption information 408 corresponding to encryption codes used for encrypting streams 410 and 412. Encryption information 408 may correspond, for example, to encryption information 269 (FIG. 2). For example, encryption information 408 may include the IVO, key index, and key index offset. In one example, demodulator 406 may extract encryption information 408 from frame headers of the received transmission, e.g., from substantially each frame header.

According to some demonstrative embodiments of the invention, receiver 400 may also include a detector 414 to generate a plurality of decrypted streams, e.g., streams 430, 432, 433 and/or 435, by decrypting the plurality of streams (“the encrypted streams”) resulting from the received signals, e.g., streams 410, 412, 413 and/or 415, respectively, as described in detail below. Stream 433 may include, for example, decrypted audio signals, e.g., corresponding to audio signals 214 (FIG. 2), which may be provided, for example, to a suitable audio module (not shown). Stream 435 may include, for example, decrypted control signals, e.g., corresponding to control signals 216 (FIG. 2), which may be provided, for example, to a modem controller (not shown).

Although embodiments of the invention are not limited in this respect, according to some demonstrative embodiments of the invention decryptor 414 may perform the functionality of decryptor 126 (FIG. 1).

According to some demonstrative embodiments of the invention, decryptor 414 may include a plurality of decryption modules to decrypt the plurality of streams based on a plurality of decryption schemes. The plurality of decryption schemes may correspond to the plurality of encryption schemes implemented to generate the encrypted transmission, e.g., the first and second encryption streams described above with reference to FIG. 2. Decryptor 414 may include, for example, a first decryption module 418 to decrypt stream 410 into decrypted stream 430 using a first decryption scheme; and a second decryption module 420 to decrypt streams 412, 413 and/or 415 into decrypted streams 432, 433 and/or 435, respectively, using a second decryption scheme.

According to some demonstrative embodiments of the invention, decryption modules 418 and 420 may use one or more common decryption codes 422 to decrypt streams 410, 412, 413 and/or 415. For example, decryptor 414 may include at least one Decryption Code Generator (DCG) 424 to generate decryption codes 422, e.g., as described in detail below.

According to some demonstrative embodiments of the invention, decryption codes 422 may include any suitable random or pseudo-random value, e.g., represented by a sequence of bits. In one example, DCG 424 may generate decryption codes 422 in accordance with any suitable block cipher technique, method or scheme, e.g., as defined by the DES, the AES, and the like.

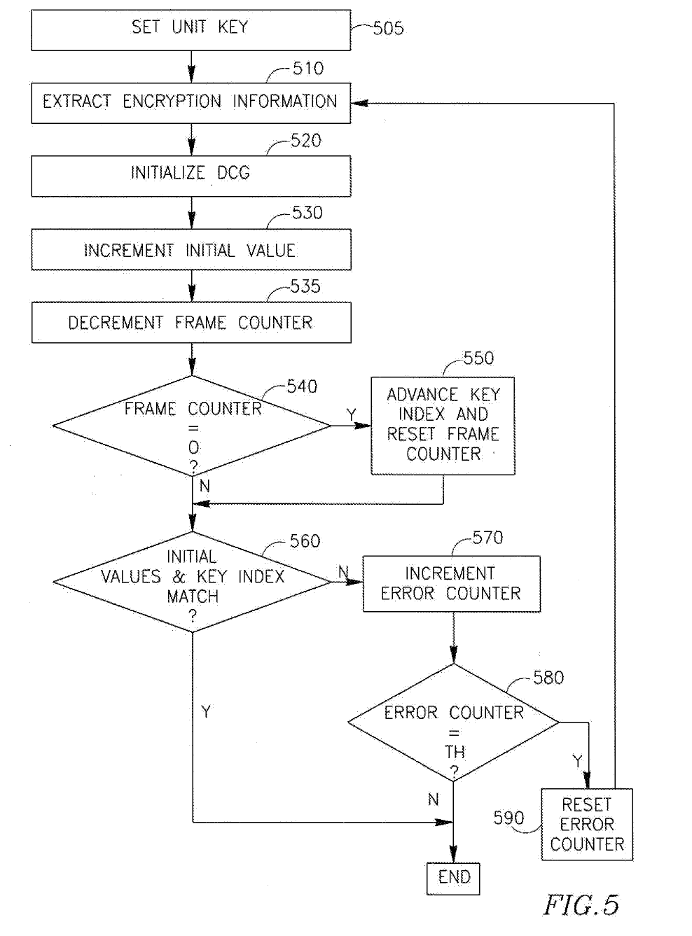

According to some demonstrative embodiments of the invention, DCG 424 may generate decryption codes 422 in synchronization with encryption codes implemented, e.g., by transmitter 200 (FIG. 2), for generating the encrypted transmission, e.g., as described in detail below with reference to FIG. 5.

According to some demonstrative embodiments of the invention, DCG 424 may generate decryption codes 422 based on a plurality of internal keys 426, a unit key 428, and an initial value 416. Keys 426 and 428, and initial value 416 may include any suitable values, e.g., represented by a sequence of bits. In one example, DCG 424 may maintain internal keys 426 in the form of a table. Internal keys 426 may be identical, for example, to internal keys 250 (FIG. 2).

According to some demonstrative embodiments of the invention, a value of unit key 428 may match a value of a unit key implemented for generating the encrypted transmission. For example, receiver 400 may coordinate the value of unit key 428 with unit key 250 (FIG. 2) of transmitter 200 (FIG. 2) using any suitable key exchange mechanism, e.g., in accordance with the RSA public key cipher, the Diffie-Hellman key exchange protocol, and the like.

According to some demonstrative embodiments of the invention, DCG 424 may generate encryption code 422 by encrypting initial value 416 using an encryption key resulting from a combination of unit key 428 and a selected internal key of internal keys 426. Decryption code 422 may be fed back as an input to DCG 424, such that additional codes 422 may be generated using a previous decryption code, e.g., instead of initial value 416. DCG 424 may select the selected internal key based on any suitable key selection criterion. For example, DCG 424 may re-select the internal key after a predefined number of frames, as described below. In one example, DCG 424 may re-select the internal key based on a frame counter 429, which may count down from a value corresponding to the key index offset, e.g., as described below with reference to FIG. 5.

Although some demonstrative embodiments of the invention are described above with reference to a decryptor, e.g., decryptor 414, including a DCG to generate decryption codes, e.g., decryption codes 422, to be provided to plurality decryption modules, e.g., decryption modules 418 and 420, in other embodiments of the invention the decryptor may include any other suitable configuration. For example, the decryptor may include a plurality of DCGs to generate the decryption codes of the plurality of decryption modules. In one example, at least first and second DCGs may generate at least first and second respective pluralities of decryption codes to be provided to the decryption modules.

According to some demonstrative embodiments of the invention, decryption module 418 may implement a first decryption scheme, e.g., to decrypt stream 410, and decryption module 420 may implement a second decryption scheme different than the first decryption scheme, e.g., to decrypt streams 412, 413, and/or 415, e.g., as described in detail below.

According to some demonstrative embodiments of the invention, the decryption scheme implemented by decryption module 420 to decrypt streams 412, 413 and/or 415 may include, for example, performing a logical operation on streams 412, 413 and/or 415 using decryption code 422. The logical operation may correspond, for example, to the logical operation performed by encryption module 236 (FIG. 2). In one example, decryption module 420 may perform a logical Boolean operator, e.g., an Exclusive-OR (XOR) operation, between decryption code 422 and each of streams 412, 413 and/or 415.

According to some demonstrative embodiment of the invention, the decryption scheme implemented by decryption module 418 to decrypt stream 410 may include, for example, performing a decryption operation on stream 410 using decryption code 422. The decryption operation may correspond, for example, to the encryption scheme implemented for encrypting symbols of stream 410, e.g., the encryption scheme implemented by encryption module 218 (FIG. 2) to encrypt the fine-constellation symbols of stream 210 (FIG. 2), as are described above.

According to some demonstrative embodiments of the invention, receiver 400 may also include a demapper 434 to demap streams 430 and 432 into an output 436. For example, demapper 434 may reconstruct transformation coefficients from fine-constellation symbols of stream 430, and coarse-constellation symbols of stream 432; perform an inverse transformation to reconstruct video component data, e.g., in the Y—Cr—Cb format; and/or convert the video component data into color component data, e.g., RGB data, as described in the '641 Application. Accordingly, output 436 may include a video signal corresponding to input video signal 204 (FIG. 2), e.g., if the transmission received by receiver 400 includes the transmission transmitted by transmitter 200 (FIG. 2).

Reference is now made to FIG. 5, which schematically illustrates a method of synchronizing encryption information, in accordance with some demonstrative embodiments of the invention. Although embodiments of the invention are not limited in this respect, according to some demonstrative embodiments the method of FIG. 5 may be implemented by a transmitter, e.g., transmitter 200 (FIG. 2) and a receiver, e.g., receiver 400 (FIG. 4), to synchronize between one or more encryption keys and/or values used by the transmitter to encrypt a transmission, and by the receiver to decrypt the transmission. For example, one or more operations of the method of FIG. 5 may be implemented to synchronize between an ECG, e.g., ECG 230 (FIG. 2), and a DCG, e.g., DCG 424 (FIG. 4), such that the DCG and ECG generate a decryption code, e.g., decryption code 422 (FIG. 4), in synchronization with an encryption code, e.g., encryption code 232 (FIG. 2).

As indicated at block 510, the method may include setting a unit value of the ECG and a unit value of the DCG to an identical value. Setting the unit values may include, for example, using any suitable key exchange mechanism, e.g., in accordance with the RSA public key cipher, the Diffie-Hellman key exchange protocol, and the like.

As indicated at block 520, the method may also include extracting encryption information from a received transmission. The encryption information may be extracted, for example, from a header of a frame received by the receiver, e.g., as described above with reference to FIG. 4. The encryption information may include, for example, IVO, key index, and key index offset values, as are described above with reference to FIG. 2. For example, the encryption information may include the IVO, key index and key index offset values used for encrypting the received frame.

As indicated at block 520, the method may include initializing the DGC. For example, the DCG may be initialized with an initial value, a key index, and a unit key. For example, DCG 424 (FIG. 4) may be initialized with unit key 428 (FIG. 4, initial value 416 (FIG. 4), and the key index, as described above. Initializing the DCG may also include, for example, initializing a frame counter to the value of the key index offset. For example, DCG 424 (FIG. 4) may initialize frame counter 429 (FIG. 4) according to the key index offset of encryption information 408 (FIG. 4).

As indicated at block 530, the method may also include incrementing the initial value by a value of the IVO extracted from the received frame, e.g., upon receiving each frame.

As indicated at block 535, the method may also include decrementing the frame counter, e.g., by one, for example, upon receiving each frame.

As indicated at block 540, the method may include determining whether the frame counter reached a predefined threshold value, e.g., zero.

As indicated at block 550, the method may include advancing the key index and resetting the frame counter to the key index value, e.g. if the frame counter has reached the threshold value.

As indicated at block 560, the method may also include comparing the key index and initial value of the DCG with the key index and initial value extracted from the received frame.

As indicated at block 580, the method may also include incrementing an error counter, e.g., by one, if for example, the key index and initial value of the DCG do not match the key index and initial value extracted from the received frame. The error counter may indicate the number of frames in which the DCG and ECG do not use synchronized encryption and decryption codes.

As indicated at block 580, the method may include determining whether the error counter reaches a predefined error threshold.

As indicated at block 590, the method may include resetting the error counter, e.g., to zero and re-initializing the DCG, e.g., as described with reference to block 510, if the error counter has reached the error threshold.

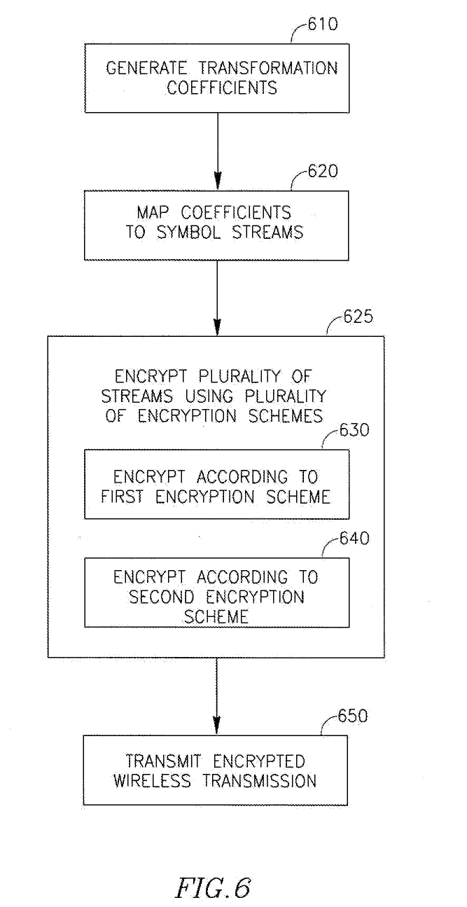

Reference is now made to FIG. 6, which schematically illustrates a method of generating an encrypted wireless transmission. Although embodiments of the invention are not limited in this respect, according to some demonstrative embodiments one or more operations of the method of FIG. 6 may be implemented by a transmitter, e.g., transmitter 06 (FIG. 1) and/or transmitter 200 FIG. 2) to generate an encrypted wireless transmission, e.g., transmission 112 (FIG. 1), corresponding to an input, e.g., signals 104 (FIG. 1) and/or 204 (FIG. 2).

As indicated at block 610, the method may include generating transformation coefficients representing the input, for example, by applying a de-correlating transform to Y—Cr—Cb components of input video signals, as described above.

As indicated at block 620, the method may also include mapping the transformation coefficients to a plurality of symbols streams. For example, the transformation coefficients may be mapped to at least a coarse-constellation symbol stream and a fine-constellation symbol stream, as described above.

As indicated at block 625, according to some demonstrative embodiments of the invention the method may also include encrypting the plurality of streams using a plurality of encryption schemes.

As indicated at block 630, the method may include encrypting a first stream of symbols, e.g., the coarse-constellation symbols, according to a first encryption scheme, e.g., by performing a XOR operation as described above with reference to FIG. 2.

As indicated at block 650, the method may also include encrypting a second stream of symbols, e.g., the time-constellation symbols, using a second encryption scheme, e.g., as described above with reference to FIG. 2.

As indicated at block 650, the method may also included transmitting an encrypted wireless transmission corresponding to the input. The transmission may include the plurality of encrypted streams encrypted according to the plurality of encrypting schemes. For example, the encrypted transmission may include at least first and second encrypted streams of symbols encrypted according to at least first and second different encryption schemes, respectively, e.g., as described above.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, an equivalents may occur to those of ordinary skill in the art. It is, therefore, to be understood that the appended claims are intended to cover all such modifications and changes as fall within the true spirit of the invention.

What is claimed is:

1. A wireless transmitter to generate an encrypted wireless transmission corresponding to an input signal, said transmission comprising at least first and second encrypted streams of symbols encrypted according to at least first and second different encryption schemes, respectively.

2. The transmitter of claim 1, wherein said first and second encrypted streams comprise symbols of first and second different constellations, respectively.

3. The transmitter of claim 2, wherein said first and second constellations comprise a fine constellation, and a coarse constellation, respectively.

4. The transmitter of claim 1, wherein said first and second encrypted streams represent a plurality of transformation coefficients corresponding to said input signal.

5. The transmitter of claim 1 comprising an encryptor to generate said first and second encrypted streams by encrypting first and second symbol streams representing said input signal.

6. The transmitter of claim 5, wherein said encryptor comprises:
an encryption code generator to generate or more encryption codes;
a first encryption module to encrypt the first symbol stream using said encryption codes according to said first encryption scheme; and
a second encryption module to encrypt the second symbol stream using said encryption codes according to said second encryption scheme.

7. The transmitter of claim 6, wherein said encryption code generator generates said encryption codes corresponding to a plurality of transmission frames.

8. The transmitter of claim 6, wherein said transmission comprises encryption information corresponding to said encryption codes.

9. The transmitter of claim 8, wherein said encryption information includes one or more encryption keys.

10. The transmitter of claim 5 comprising:
a coefficient generator to apply a transformation to said input signal to generate a plurality of transformation coefficients representing said input signal; and
a mapper to map said transformation coefficients to said first and second symbol streams.

11. The transmitter of claim 1, wherein said input signal comprises a video signal.

12. The transmitter of claim 11, wherein said video signal comprises a high-definition, television signal.

13. A wireless receiver to receive an encrypted wireless transmission representing an input signal and to decrypt the transmission into an output signal corresponding to said input signal, said transmission comprising at least first and second encrypted streams of symbols encrypted according to at least first and second different encryption schemes, respectively.

14. The receiver of claim 13, wherein said first and second encrypted streams comprise symbols of first and second different constellations, respectively.

15. The receiver of claim 14, wherein said first and second constellations comprise a fine constellation, and a coarse constellation, respectively.

16. The receiver of claim 13, wherein said first and second encrypted streams represent a plurality of transformation coefficients, and wherein said output signal is based on said plurality of transformation coefficients.

17. The receiver of claim 13 comprising a decryptor to decrypt said first and second encrypted streams into first and second decrypted symbol streams.

18. The receiver of claim 17, wherein said decryptor comprises:
a encryption code generator to generate one or more decryption codes;
a first decryption module to decrypt the first encrypted stream using said decryption codes according to a first decryption scheme corresponding to said first encryption scheme; and
a second decryption module to decrypt the second encrypted stream using said decryption codes according to a second decryption scheme corresponding to said second encryption scheme.

19. The receiver of claims 18, wherein said decryption code generator generates said decryption codes corresponding to a plurality of received transmission frames.

20. The receiver of claim 18, wherein said received transmission comprises encryption information, and wherein, said decryption code generator generates said decryption codes based on said encryption information.

21. The receiver of claim 20, wherein said encryption information includes one or more encryption keys used to encrypt said first and second encrypted streams.

22. The receiver of claim 13, wherein said output signal comprises a video signal.

23. The receiver of claim 22, wherein said video signal comprises a high-definition-television signal.

24. A wireless communication system comprising:
a source module to generate a signal to be transmitted to a destination module; and
a wireless transmitter to generate an encrypted wireless transmission corresponding to said signal, said transmission comprising at least first and second encrypted streams of symbols encrypted according to at least first and second different encryption schemes, respectively.

25. The system of claim 24, wherein said source module comprises a video source, and wherein said signal comprises a video signal.

26. The system of claim 24 comprising a receiver to receive said encrypted wireless transmission and to decrypt said transmission into an output signal.

27. The system of claim 24, wherein said first and second encrypted streams comprise symbols of first and second different constellations, respectively.

28. The system of claim 24, wherein said first and second encrypted streams represent a plurality of transformation coefficients corresponding to said signal.

29. A method of encrypted wireless communication, the method comprising:
transmitting an encrypted wireless transmission corresponding to an input signal, said transmission comprising at least first and second encrypted streams of symbols encrypted according to at least first and second different encryption schemes, respectively.

30. The method of claim 29, wherein said first and second encrypted streams comprise symbols of first and second different constellations, respectively.

31. The method of claim 29, wherein said first and second encrypted streams represent a plurality of transformation coefficients corresponding to said input signal.

32. The method of claim 29 comprising encrypting first and second symbol streams representing said input signal to generate said first and second encrypted streams.

33. The method of claim 32, wherein said encrypting comprises:
generating one or more encryption codes;
encrypting the first symbol stream using said encryption codes according to said first encryption scheme, and
encrypting the second symbol stream using said encryption codes according to said second encryption scheme.

34. The method of claim 32 comprising:
receiving said encrypted wireless transmission; and
decrypting the transmission into a decrypted output signal corresponding to said input signal.

35. The method of claim 32, wherein said input signal comprises a video signal.

36. A method of encrypted wireless communication, the method comprising:
receiving an encrypted wireless transmission representing an input signal; and
decrypting the transmission into a decrypted output signal corresponding to said input signal, said transmission comprising at least first and second encrypted streams of symbols encrypted according to at least first and second different encryption schemes, respectively.

37. The method of claim 36, wherein said first and second encrypted steams comprise symbols of first and second different constellations, respectively.

38. The method of claim 36, wherein said first and second encrypted streams represent a plurality of transformation coefficients, and wherein said output signal is based on said plurality of transformation coefficients.

39. The method of claim 36, wherein decrypting said transmission comprises decrypting said first and second encrypted streams into first and second decrypted symbol streams.

40. The method of claim 39, wherein decrypting said first and second encrypted streams comprises:
generate one or more decryption codes;
decrypting the first encrypted stream using said decryption codes according to a first decryption scheme corresponding to said first encryption scheme; and
decrypting the second encrypted stream using said decryption codes according to a second decryption scheme corresponding to said second encryption scheme.

41. The method of claim 40, wherein generating said decryption codes comprises generating said decryption codes corresponding to a plurality of received transmission frames.

42. The method of claim 36, wherein said output signal comprises a video signal.
